(19) United States
(12) Patent Application Publication
(10) Pub. No.: US 2009/0042032 A1
(43) Pub. Date: Feb. 12, 2009

(54) NOVEL WATER-SOLUBLE NANOCRYSTALS COMPRISING A LOW MOLECULAR WEIGHT COATING REAGENT, AND METHODS OF PREPARING THE SAME

(75) Inventors: Mingyong Han, Singapore (SG); Fuke Wang, Singapore (SG)

Correspondence Address: SEED INTELLECTUAL PROPERTY LAW GROUP PLLC, 701 FIFTH AVE, SUITE 5400, SEATTLE, WA, 98104, US

(73) Assignee: AGENCY FOR SCIENCE, TECHNOLOGY AND RESEARCH, Singapore (SG)

(21) Appl. No.: 11/913,671

(22) PCT Filed: May 4, 2005
(86) PCT No.: PCT/SG2005/000138

§ 371 Date: Sep. 2, 2008

(51) Int. Cl. B32B 1/00

(52) U.S. Cl. 428/402; 977/774

(57) ABSTRACT

The invention relates to a water soluble nanocrystal with a nanocrystal core comprising at least one metal M1 selected form an element of main group II, VIIA, subgroup VIIA, subgroup IB, subgroup IIB, main group III or main group IV of the periodic system of the elements (PSE), at least one element A selected from main group V or main group VI of the PSE, a capping reagent attached to the surface of the core of the nanocrystal, said capping reagent having at least two coupling groups, and a second layer comprising a low molecular weight coating reagent having at least two coupling moieties covalently coupled with the coating reagent, and at least one water soluble group for conferring water solubility to the second layer.

The invention relates to novel water-soluble nanocrystals and to methods of making the same. The invention also relates to the uses of such nanocrystals, including but not limited to, in various analytical and biomedical applications such as the detection and/or visualization of biological materials or processes, e.g. in tissue or cell imaging, in vitro or in vivo. The present invention also relates to compositions and kits containing such nanocrystals which can be used in the detection of analytes such as nucleic acids, proteins or other biomolecules.

Semiconductor nanocrystals (quantum dots) have been receiving great fundamental and technical interest for their use in a variety of technologies, such as light-emitting devices (Colvin et al, Nature 370, 354-357, 1994; Tessler et al, Science 295, 1506-1508, 2002), lasers (Klimov et al, Science 290, 314-317, 2000), solar cells (Huynh et al, Science 295, 2425-2427, 2002) or as fluorescent biological labels in biochemical research areas such as cell biology. For example, see Bruchez et al, Science, Vol. 281, pages 2013-2015, 2001; Chan & Nie, Science, Vol. 281, pages 2016-2018, 2001; U.S. Pat. No. 6,207,392, summarized in Klarreich, Nature, Vol. 43, pages 450-452, 2001; see also Mitchell, Nature Biotechnology, pages 1013-1017, 2001, and U.S. Pat. Nos. 6,423,551, 6,306,610, and 6,326,144.

The development of sensitive non-isotopic detection systems for use in biological assays has significantly impacted many research and diagnostic areas, such as DNA sequencing, clinical diagnostic assays, and fundamental cellular and molecular biology protocols. Current non-isotopic detection methods are mainly based on organic reporter molecules that undergo color change or are fluorescent, luminescent. Fluorescent labeling of molecules is a standard technique in biology. The labels are often organic dyes that give rise to the usual problems of broad spectral features, short lifetime, photobleaching, and potential toxicity to cells. The recent emerging technology of quantum dots has spawned a new era for development of fluorescent labels using inorganic complexes or particles. These materials offer substantial advantages over organic dyes including large Stocks shift, longer emission half-life, narrow emission peak and minimal photo-bleaching (cf. references cited above).

Over the past decade, much progress has been made in the synthesis and characterization of a wide variety of semiconductor nanocrystals. Recent advances have led to large-scale preparation of relatively monodisperse quantum dots. (Murray et al., J. Am. Chem. Soc., 115, 8706-15, 1993; Bowen Katari et al., J. Phys. Chem. 98, 4109-17, 1994; Hines, et al., J. Phys. Chem. 100, 468-71, 1996. Dabbousi, et al., J. Phys. Chem. 101, 9463-9475, 1997.)

Further advances in luminescent quantum dot technology have resulted in an enhancement of the fluorescence efficiency and stability of the quantum dots. The remarkable luminescent properties of quantum dots arise from quantum size confinement, which occurs when metal and semiconductor core particles are smaller than their excitation Bohr radii, about 1 to 5 nm. (Alivisatos, Science, 271, 933-37, 1996; Alivisatos, J. Phys. Chem. 100, 13226-39, 1996; Brus, Appl Phys., A53, 465-74, 1991; Wilson et al., Science, 262, 1242-46, 1993.) Recent work has shown that improved luminescence can be achieved by capping a size-tunable lower bandgap core particle with a higher band gap inorganic materials shell. For example, CdSe quantum dots passivated with a ZnS layer are strongly luminescence at room temperature, and their emission wavelength can be tuned from blue to red by changing the particle size. Moreover, the ZnS capping layer passivates surface nonradiative recombination sites and leads to greater stability of the quantum dot. (Dabbousi et al., J. Phys. Chem. B101, 9463-75, 1997. Kortan, et al., J. Am. Chem. Soc. 112, 1327-1332, 1990.)

Despite the progress in luminescent quantum dots technology, the conventional capped luminescent quantum dots are not suitable for biological applications because they are not water-soluble.

In order to overcome this problem, the organic passivating layer of the quantum dots were replaced with water-soluble moieties. However, the resultant quantum dots are not highly luminescent (Zhong et al., J. Am. Chem. Soc. 125, 8589, 2003). Short chain thiols such as 2-mercaptoethanol and 1-thioglycerol have also been used as stabilizers in the preparation of water-soluble CdTe nanocrystals. (Rogach et al., Ber. Bunsenges. Phys. Chem. 100, 1772, 1996; Rajh et al., J. Phys. Chem. 97, 11999, 1993). In another approach, Coffer et al., describe the use of deoxyribonucleic acid (DNA) as a water soluble capping compound (Coffer, et al., Nanotechnology 3, 69, 1992). In all of these systems, the coated nanocrystals were not stable and photoluminescent properties degraded with time.

In a further study, Spanhel et al. disclosed a Cd(OH)₂-capped CdS sol (Spanhel, et al., J. Am. Chem. Soc. 109, 5649, 1987). However, the colloidal nanocrystals could be prepared only in a very narrow pH range (pH 8-10) and exhibited a narrow fluorescence band at a pH of greater than 10. Such pH dependency greatly limits the usefulness of the material, and in particular, it is not appropriate for use in biological systems.

The PCT publication WO 00/17656 discloses core-shell nanocrystals which are capped with a carboxyl acid or sulfonic acid compound of the formula SH(CH₂)ₙ—COOH and SH(CH₂)ₙ—SO₃H, respectively in order to render the nanocrystals water soluble. Similarly, the PCT application WO 00/29617 and British patent application GB 2342651 describe that organic acids such as mercaptoacetic acid or mercapto-undecanoic acid are attached to the surface of nanocrystals to render them water soluble and suitable for conjugation of biomolecules such as proteins or nucleic acids. GB 2342651 also describes the use of trioctylphosphine as capping material that is supposed to confer water solubility of the nanocrystals.

Another approach is taught in PCT publication WO 00/27365, which reports the use of diaminocarboxylic acids as water-solubilising agents. In this PCT publication, the diamino acids are linked to the nanocrystal core by monovalent capping compounds.

PCT publication WO 00/17655 discloses nanocrystals that are rendered water-soluble by the use of a solubilising agent that has a hydrophilic moiety and a hydrophobic moiety. The solubilising agent attaches to the nanocrystal via the hydrophobic group, whereas the hydrophilic group, such as a carboxylic acid or methacrylic acid, provides for water solubility.

In a further PCT application (WO 02/073155), water soluble semiconductor nanocrystals are described in which various molecules such as trioctylphosphin oxide hydroxamates, derivatives of hydroxamic acid or multidentate complexing agents such as ethylenediamine are directly attached to the surface of a nanocrystal to render them water-soluble. These nanocrystals can then be linked to a protein via EDC. In another approach, the PCT application WO 00/58731 discloses nanocrystals which are used for the analysis of blood cell populations and in which amino-derived polysaccharides having a molecular weight from about 3,000 to about 3,000,000 are linked to the nanocrystals.

U.S. Pat. No. 6,699,723 discloses the use of silane-based compounds as linking agent to facilitate the attachment of biomolecules such as biotin and streptavidin to luminescent nanocrystal probes. US Patent Application No. 2004/0072373 A1 describes a method of biochemical labeling using silane-based compounds. Silane-linked nanoparticles are bonded to template molecules by molecular imprinting, and then polymerized to form a matrix. Thereafter, the template molecules are removed from the matrix. The cavity produced in the matrix due to the removal of the template molecule has properties that can be used for labeling.

Recently, the use of synthetic polymers to stabilize water soluble nanocrystals have been reported. US Patent Application No. 2004/0115817 A1 describes that of amphiphilic, diblock polymers can be attached non covalently via hydrophobic interactions to a nanocrystal, the surface of which is coated with agents such as trioctylphosphine or trioctylphosphine oxide. Similarly, Gao et al. (Nature Biotechnology, Vol. 22, 969-976, August 2004) disclose water soluble semiconductor nanocrystals that are encapsulated with amphiphilic, tri-block copolymers via non covalent hydrophobic interactions.

Despite these developments, there remains a need for nanocrystals that can be used for detection purposes in biological assays. In this respect, it would be is desirable to have nanocrystals that can be attached to a biomolecule in a manner that preserves the biological activity of the biomolecule. Furthermore, it would be desirable to have water-soluble semiconductor nanocrystals which can be prepared and stored as stable, robust suspensions or solutions in aqueous media. Finally, these water-soluble nanocrystals quantum dots should be capable of energy emission with high quantum efficiencies, and should possess a narrow particle size.

Accordingly, it is an object of the invention to provide nanocrystals that meet the above needs.

This object is solved by the nanocrystals and the processes of producing nanocrystals having the features of the respective independent claims.

In one aspect, the invention is directed to a water soluble nanocrystal comprising:

a nanocrystal core comprising at least one metal M1 selected from an element of subgroup Ib, subgroup IIb, subgroup IVb, subgroup Vb, subgroup VIb, subgroup VIIb, subgroup VIIIb, main group II, main group III or main group IV of the periodic system of the elements (PSE), and further comprising
a first layer comprising a capping reagent attached to the surface of the core of the nanocrystal, said capping reagent having at least two coupling groups,
and a second layer comprising a low molecular weight coating reagent having at least two coupling moieties covalently coupled with the coating reagent, and at least one water soluble group for conferring water solubility to the second layer.

The water soluble nanocrystal is obtainable by a method comprising:

reacting a nanocrystal core as defined above with a capping reagent, thereby attaching the capping reagent to the surface of the nanocrystal core and forming a first layer surrounding the nanocrystal core,

and

coupling the capping reagent with a low molecular weight coating reagent having at least at least two coupling moieties that are reactive towards the at least two coupling groups of the capping reagent, and at least one water soluble group for conferring water solubility to the second layer, thereby forming a second layer covalently coupled to the first layer and completing the formation of a water soluble shell surrounding the nanocrystal core.

In another aspect, the invention is directed to a water soluble nanocrystal comprising:

a nanocrystal core comprising at least one metal M1 selected from an element of main group II, subgroup VIIA, subgroup VIIIA, subgroup IB, subgroup IIB, main group III or main group IV of the periodic system of the elements (PSE), and at least one element A selected from main group V or main group VI of the PSE, and further comprising
a first layer comprising a capping reagent attached to the surface of the core of the nanocrystal, said capping reagent having at least two coupling groups,
and a second layer comprising a low molecular weight coating reagent having at least two coupling moieties covalently coupled with the coating reagent, and at least one water soluble group for conferring water solubility to the second layer.

The water soluble nanocrystal is obtainable by a method comprising:

reacting a nanocrystal core as defined above with a capping reagent, thereby attaching the capping reagent to the surface of the nanocrystal core and forming a first layer surrounding the nanocrystal core,

and

coupling the capping reagent with a low molecular weight coating reagent having at least at least two coupling moieties that are reactive towards the at least two coupling groups of the capping reagent, and at least one water soluble group for conferring water solubility to the second layer, thereby forming a second layer covalently coupled to the first layer and completing the formation of a water soluble shell surrounding the nanocrystal core.

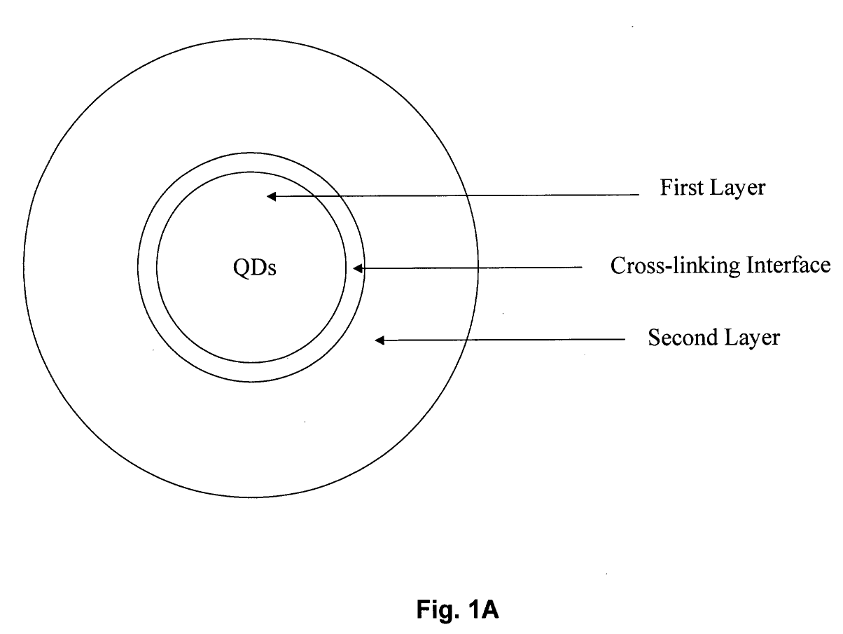

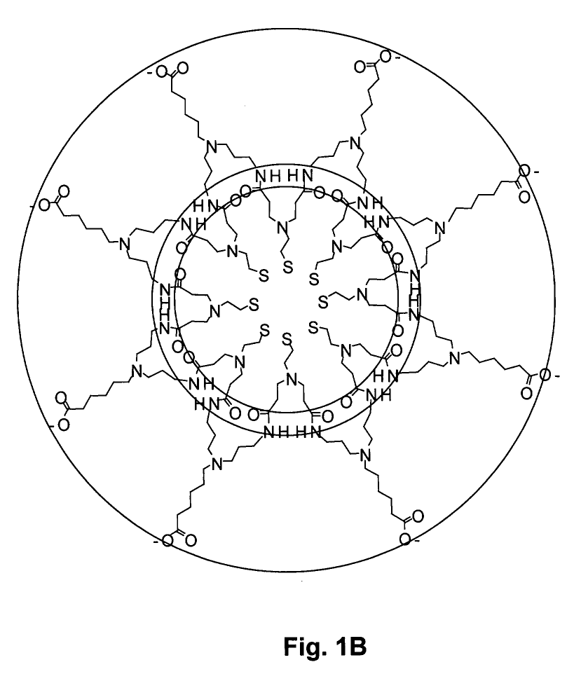

Traditional methods of coating nanocrystals typically do not involve covalent bonding at the interface between the water soluble shell covering the nanocrystal core. In the invention, both capping reagents comprising small monomers or low molecular weight oligomeric molecules are first used to cap the nanocrystal surface (for example, to form a metal-sulfur or metal-nitrogen bond) to form a capping reagent layer, also known as the first layer. This first layer is covalently bonded to the nanocrystal core. This step is followed by coupling of a low molecular weight coating reagent bearing water soluble groups to the capping reagent in the presence of a coupling agent. The coupling results in the formation of a water soluble shell over the nanocrystal core. The shell is attached and immobilized onto the surface of a nanocrystal core (see also FIG. 1). As the low molecular weight coating reagent forms a covalently cross-linked layer surrounding the nanocrystal core, it helps to ensure that the shell is kept intact and attached to the nanocrystal core, thereby reducing the likelihood of having the water soluble shell detach from the nanocrystal.

In another aspect, the invention is directed to a method of preparing a water soluble nanocrystal having a core as defined above comprising:

providing a nanocrystal core as defined above,

reacting the nanocrystal core with a capping reagent, thereby attaching the capping reagent to the surface of the nanocrystal core and forming a first layer surrounding the nanocrystal core,

and

coupling the capping reagent with a low molecular weight coating reagent having at least at least two coupling moieties that are reactive towards the at least two coupling groups of the capping reagent, and at least one water soluble group for conferring water solubility to the second layer, thereby forming a second layer covalently coupled to the first layer and completing the formation of a water soluble shell surrounding the nanocrystal core.

The present invention is based on the finding that water soluble nanocrystals can be effectively stabilized through the formation of a water soluble shell surrounding the nanocrystal. This shell comprises a first layer (comprising a capping reagent) covalently bonded to the surface of the nanocrystal core, and a second layer comprising a low molecular weight coating reagent covalently coupled or covalently cross-linked to the first layer. It is found that a water soluble shell synthesized in this manner allows the nanocrystal to stay in an aqueous environment for a reasonably long period of time without any substantial loss of luminescence. Without wishing to be bound by theory, it is believed that the improved stability of the nanocrystals can be attributed to the protective function of the water-soluble shell. The shell behaves as a hermetic box or protective barrier that reduces contact between the nanocrystal core and reactive water-soluble species such as ions, radicals or molecules that may be present. This is useful for preventing the aggregation of nanocrystals in an aqueous environment. It is thought that in so doing the nanocrystals are kept electrically isolated from each other, thereby also prolonging its photoluminescence. By using low-molecular weight compounds as the coating reagent, the reaction between the first layer and second layer can be controlled easily. Furthermore, the use of low-molecular weight compounds as the coating reagent results in nanocrystals that are small in size and have smooth surface morphologies. Another advantage is that the shell thus formed can also be advantageously functionalized via the attachment of suitable biological molecules or analytes that can facilitate recognition of a huge variety of biological material such as tissues and organ targets. By implementing different combinations of capping reagents and low molecular weight coating reagents to form the water-soluble shell, the present invention presents an elegant route to a new class of water soluble nanocrystals having improved chemical and physical properties which are useful for a wide variety of applications.

In accordance with the invention, any suitable type of nanocrystal (quantum dot) can be rendered water soluble, so as long as the surface of the nanocrystal can be attached with a capping reagent. In this context, the terms “nanocrystal” and “quantum dot” are used interchangeably.

In one embodiment, suitable nanocrystals have a nanocrystal core comprising metal alone. For this purpose, M1 may be selected from the group consisting of an element of main group II, subgroup VIIA, subgroup VIIIA, subgroup IB, subgroup IIB, main group III or main group IV of the periodic system of the elements (PSE). Accordingly, the nanocrystal core may consist of only the metal element M1; the non-metal element A or B, as defined below, is absent. In this embodiment, the nanocrystal consists only of a pure metal from any of the above groups of the PSE, such as gold, silver, copper (subgroup Ib), titanium (subgroup IVb), terbium (subgroup IIIb), cobalt, platinum, rhodium, ruthenium (subgroup VIIb), lead (main group IV) or an alloy thereof. While the invention is mainly illustrated in the following with reference only to nanocrystals comprising a counter element A, it is understood that nanocrystals consisting of a pure metal or a mixture of pure metals can also be used in the invention.

In another embodiment, the nanocrystal core used in the present invention may comprise two elements. Accordingly, the nanocrystal core may be a binary nanocrystal alloy comprising two metal elements, M1 and M2, such as any well-known core-shell nanocrystal formed from metals such as Zn, Cd, Hg, Mg, Mn, Ga, In, Al, Fe, Co, Ni, Cu, μg, Au and Au. Another type of binary nanocrystals suitable in the present invention may comprise one metal element M1, and at least one element A selected from main group V or main group VI of the PSE. Accordingly, the one type of nanocrystal suitable for use presently has the formula M1A. Examples of such nanocrystals may be group II-VI semiconductor nanocrystals (i.e. nanocrystals comprising a metal from main group II or subgroup IIB, and an element from main group VI) wherein the core and/or the shell (the term “shell” as used herein is different and separate from the water soluble “shell” made from organic molecules that enclosed the nanocrystal) includes CdS, CdSe, CdTe, MgTe, ZnS, ZnSe, ZnTe, HgS, HgSe, or HgTe. The nanocrystal core may also be any group III-V semiconductor nanocrystal (i.e. nanocrystals comprising a metal from main group III and an element from main group V). The core and/or the shell includes GaN, GaP, GaAs, GaSb, InN, InP, InAs, InSb, AlN, AlP, AlAs, AlSb. Specific examples of core shell nanocrystals that can be used in the present invention include, but are not limited to, (CdSe)-nanocrystals having a ZnS shell, as well as (CdS)-nanocrystals having ZnS shell.

The invention is not limited to the use of the above-described core-shell nanocrystals. In another embodiment, the nanocrystal of the invention can have a core consisting of a homogeneous ternary alloy having the composition M1₁₋ₓM2ₓA, wherein

a) M1 and M2 are independently selected from an element of subgroup IIb, subgroup VIIa, subgroup VIIIa, subgroup Ib or main group II of the periodic system of the elements (PSE), when A represents an element of the main group VI of the PSE, or

b) M1 and M2 are both selected from an element of the main group (III) of the PSE, when A represents an element of the main group (V) of the PSE.

In another embodiment nanocrystal consisting of a homogeneous quaternary alloy can be used. Quaternary alloys of this type have the composition M1₁₋ₓM2ₓA_{y}B_{1-y}, wherein

a) M1 and M2 are independently selected from an element of subgroup IIb, subgroup VIIa, subgroup VIIIa, subgroup Ib or main group II of the periodic system of the elements (PSE), when A and B both represent an element of the main group VI of the PSE, or

b) M1 and M2 are independently selected from an element of the main group (III) of the PSE, when A and B both represent an element of the main group (V) of the PSE.

Examples of this type of homogenous ternary or quaternary nanocrystals have been described, for instance, in Zhong et al, J. Am. Chem. Soc, 2003 125, 8598-8594, Zhong et al, J. Am. Chem. Soc, 2003 125, 13559-13553, or the International patent application WO 2004/054923.

The designation M1 and M2 as used in the formula described above may be used interchangeably throughout the specification. For example, an alloy comprising Cd and Hg can be designated by M1 or M2 as well as M2 and M1, each respectively. Likewise, the designation A and B for elements of group V or VI of the PSE are used interchangeably; thus in an quaternary alloy of the invention Se or Te can both be named as element A or B.

Such ternary nanocrystals are obtainable by a process comprising forming a binary nanocrystal M1A by

i) heating a reaction mixture containing the element M1 in a form suitable for the generation of a nanocrystal to a suitable temperature T1, adding at this temperature the element A in a form suitable for the generation of a nanocrystal, heating the reaction mixture for a sufficient period of time at a temperature suitable for forming said binary nanocrystal M1A and then allowing the reaction mixture to cool, and

ii) reheating the reaction mixture, without precipitating or isolating the formed binary nanocrystal M1A, to a suitable temperature T2, adding to the reaction mixture at this temperature a sufficient quantity of the element M2 in a form suitable for the generation of a nanocrystal, then heating the reaction mixture for a sufficient period of time at a temperature suitable for forming said ternary nanocrystal M1₁₋ₓM2ₓA and then allowing the reaction mixture to cool to room temperature, and isolating the ternary nanocrystal M1₁₋ₓM2ₓA.

In these ternary nanocrystals, the index x has a value of 0.001<x<0.999, preferably of 0.01<x<0.99, 0.1<0.9 or more preferred of 0.5<x<0.95. In even more preferred embodiments, x can have a value between about 0.2 or about 0.3 to about 0.8 or about 0.9. In the quaternary nanocrystals employed here, y has a value of 0.001<y<0.999, preferably of 0.01<y<0.99, or more preferably of 0.1<x<0.95 or between about 0.2 and about 0.8.

In the II-VI ternary nanocrystals, the elements M1 and M2 comprised therein are preferably independently selected from the group consisting of Zn, Cd and Hg. The element A of the group VI of the PSE in these ternary alloys is preferably selected from the group consisting of S, Se and Te. Thus, all combinations of these elements M1, M2 and A are within the scope of the invention. In preferred embodiments nanocrystals used have the composition ZnₓCd₁₋ₓSe, ZnₓCd₁₋ₓS, ZnₓCd₁₋ₓTe, HgₓCd₁₋ₓSe, HgₓCd₁₋ₓTe, HgₓCd₁₋ₓS, ZnₓHg₁₋ₓSe, ZnₓHg₁₋ₓTe, and ZnₓHg₁₋ₓS.

In some preferred embodiments, x as used in the above chemical formulas has a value of 0.10<x<0.90 or 0.15<x<0.85, and more preferably a value of 0.2<x<0.8. In particularly preferred embodiments, the nanocrystals have the composition ZnₓCd₁₋ₓS and ZnₓCd₁₋ₓSe. Such nanocrystals are preferred in which x has a value of 0.10<x<0.95, and more preferably a value of 0.2<x<0.8.

In certain embodiments in which the nanocrystal core is made from III-V nanocrystals of the invention, each of the elements M1 and M2 are independently selected from Ga and In. The element A is preferably selected from P, As and Sb. All possible combinations of these elements M1, M2 and A are within the scope of the invention. In some presently preferred embodiments, nanocrystals have the composition GaₓIn₁₋ₓP, GaₓIn₁₋ₓAs and GaₓIn₁₋ₓAs.

In the invention, the nanocrystal core is encased in a water soluble shell which comprises 2 main components. The first component of the water soluble shell is a capping reagent that has affinity for the surface of the nanocrystal core and that forms the first layer of the water soluble shell. The second component is the low molecular weight coating reagent that is coupled to the capping reagent and which forms the second layer of the water soluble shell

All types of small molecules or oligomers which have binding affinity to surface of nanocrystals may be used as capping reagents for forming the first layer. In one embodiment, only one type of compound is used as the capping reagent. In other embodiments, mixtures of 2, 3, 4 or more (or at least 2) different compounds are used as the capping reagent. Preferred capping reagents are organic molecules and which have, firstly, at least one moiety that can attach or covalently bond to in order to be immobilized on the surface of the nanocrystal core, and, secondly, at least two coupling groups that provide for subsequent coupling with the coating reagent. The coupling group may react directly with the coupling moieties present in the coating reagent, or it may react indirectly, e.g. require activation by a coupling agent, in order to proceed with the coupling reaction. Each of these moieties may be present in the capping reagent either at a terminal location on the molecule, or at a non-terminal location along the main chain of the molecule.

In one embodiment, the capping reagent comprises one moiety having affinity for the surface of the core of the nanocrystal, said moiety being located at a terminal position on the capping reagent molecule. The interaction between the nanocrystal core and the moieties may arise from hydrophobic or electrostatic interaction, or from covalent or coordinative bonding. Suitable terminal groups include moieties that have free (unbonded) electron pairs, thereby enabling the capping reagent to be bonded to the surface of the nanocrystal core. Exemplary terminal groups comprise moieties containing S, N, P atoms or a P═O group. Specific examples of these moieties include amine, thiol, amine-oxide and phosphine, for example.

In a further embodiment, the capping reagent further comprises at least one coupling group spaced apart from the terminal group by a hydrophobic region. Each coupling group may comprise any suitable number of main chain carbon atoms, and any suitable functional group that can react with a complementary coupling moiety on the coating reagent which is used to form the second layer of the water soluble shell. Exemplary coupling moieties may be selected from the group consisting of hydroxy (—OH), amino (—NH₂), carboxyl (—COOH), carbonyl (—CHO), cyano groups (—CN).

In a preferred embodiment, the capping reagent comprises two coupling group spaced apart from the terminal group by a hydrophobic region, as illustrated in the following general formula (G1):

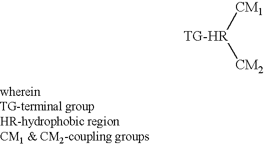

In the formula G1 above, the coupling groups CM1 and CM2 may be hydrophilic. Examples of hydrophilic coupling groups include —NH2, —COOH or OH functional groups. Other examples include nitrile, nitro, isocyanate, anhydride, epoxide and halide groups. Coupling groups may be hydrophobic. A capping reagent having a combination of hydrophobic and hydrophilic groups may be used. Some examples of hydrophobic groups include an alkyl moiety, an aromatic ring, or a methoxy group. Each coupling group may be independently selected, and a combination of a hydrophilic capping reagents and hydrophobic capping reagents may be used simultaneously.

Without wishing to be bound by theory, it is believed that the hydrophobic region in the capping reagent as defined in formula (G1) is capable of shielding the nanocrystal core from charged species present in an aqueous environment. Charge transfer from the aqueous environment to the surface of the nanocrystal core becomes hindered by the hydrophobic region, thereby minimizing premature quenching of intermediate nanocrystals (i.e. nanocrystals that are capped with the capping reagent) during synthesis. Thus, the presence of the hydrophobic region in the capping reagent can help to improve the final quantum yield of the nanocrystals. Examples of hydrophobic moieties suitable for this purpose include hydrocarbon moieties, including all aliphatic straight-chained, cyclic, or aromatic hydrocarbon moieties.

In one embodiment, the capping reagent used in the nanocrystal of the invention has the general formula (I):

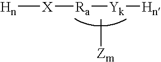

In this formula, X represents a terminal group that has affinity for the surface of the nanocrystal core. X may be selected from S, N, P, or O═P. Specific examples of the moiety Hₙ—X— may include any one of the following: H—S—, O═P—, and H₂N—, for example. Rₐ is a moiety comprising at least 2 main chain carbon atoms, and thus possesses hydrophobic character. If Rₐ is predominantly hydrophobic in character, e.g. a hydrocarbon, it then provides a hydrophobic region separating moiety Z from the nanocrystal core. The moiety Y is selected from N, C, —COO—, or —CH₂O—. Z is a moiety that comprises at least one coupling moiety for subsequent polymerization, and which thus confers a predominantly hydrophilic character to a portion of the hydrophilic capping reagent. Exemplary polar functional groups include, but are not limited to —OH, —COOH, —NH₂, —CHO, —CONHR, —CN, —NCO, —COR and halides. The numerals in the formula are represented by the symbols k, n, n′ and m. λ is 0 or 1. The numeral n is an integer from 0 to 3 and n′ is an integer from 0 to 2; both are selected in order to satisfy the valence requirement of X and Y respectively. The numeral m is an integer from 1 to 3. The numeral k is 0 or 1. The condition applies that if k is 0, Z will be bonded to Rₐ. The value of k=0 caters to the case where the coupling moiety Z is directly bonded to Rₐ where, for example, Rₐ is a cyclic moiety, e.g. aliphatic cycloalkanes, aromatic hydrocarbons or heterocycles. However, it is possible that Rₐ is a cyclic moiety when k=1, e.g. a tertiary amino group bonded to a benzene ring, or a cyclic hydrocarbon. In the present formula, Z is a functional group selected from the group consisting of amino, hydroxyl, carbonyl, carboxyl, nitrile, nitro, isocyanate, epoxide, anhydride and halide groups. Either Y or Z can function as a coupling group. If Z is present as a coupling group, then Y may function as a structural component for attaching coupling group Z. If Z is absent, Y may then form part of the coupling group.

The moiety Rₐ in the above formula may comprise between several tens to several hundred main chain atoms. In one particular embodiment, each of Rₐ and Z independently comprises 2 to 50 main chain atoms. Z may comprise one or more amide or ester linkages. Examples of suitable moieties which can be used for Rₐ include alkyl, alkenyl, alkoxy and aryl moieties.

The term “alkyl” as used herein refers to a branched or unbranched, straight-chained or cyclic saturated hydrocarbon group, generally comprising 2 to 50 carbon atoms, such as methyl, ethyl, n-propyl, isopropyl, n-butyl, isobutyl, t-butyl, octyl, decyl, tetradecyl, hexadecyl, eicosyl, tetracosyl, as well as cycloalkyl groups such as cyclopentyl, cyclohexyl, for instance. The term “alkenyl” as used herein refers to a branched or unbranched hydrocarbon group generally comprising 2 to 50 carbon atoms and containing at least one double bond, typically containing one to six double bonds, more typically one or two double bonds, e.g. ethenyl, n-propenyl, n-butenyl, octenyl, decenyl, as well as cycloalkenyl groups, such as cyclopentenyl, cyclohexenyl, for instance. The term “alkoxy” as used herein refers to a substituent —O—R wherein R is alkyl as defined above. The term “aryl” as used herein, and unless otherwise specified, refers to an aromatic moiety containing one or more aromatic rings. Aryl groups are optionally substituted with one or more inert, non-hydrogen substituents on the aromatic ring, and suitable substituents include, for example, halo, haloalkyl (preferably halo-substituted lower alkyl), alkyl (preferably lower alkyl), alkenyl (preferably lower alkenyl), alkynyl (preferably lower alkynyl), alkoxy (preferably lower alkoxy), alkoxycarbonyl (preferably lower alkoxycarbonyl), carboxy, nitro, cyano and sulfonyl. In all embodiments, Rₐ may include heteroaromatic moieties which generally comprise heteroatoms such as nitrogen, oxygen or sulfur.

In preferred embodiments, Rₐ is selected from the group consisting of ethyl, propyl, butyl and pentyl, cyclopentyl, cyclohexyl, cyclo-octyl, ethoxy, propoxy, butoxy, benzyl, purine, pyridine, imidazole, moieties.

In another embodiment, the at least two coupling groups of the capping reagent may be homo-bifunctional or hetero-bifunctional, meaning that they may comprise at least two identical coupling groups or two different coupling groups, respectively. Illustrative examples of some suitable capping reagents with two or three coupling groups have respective structures as follows:

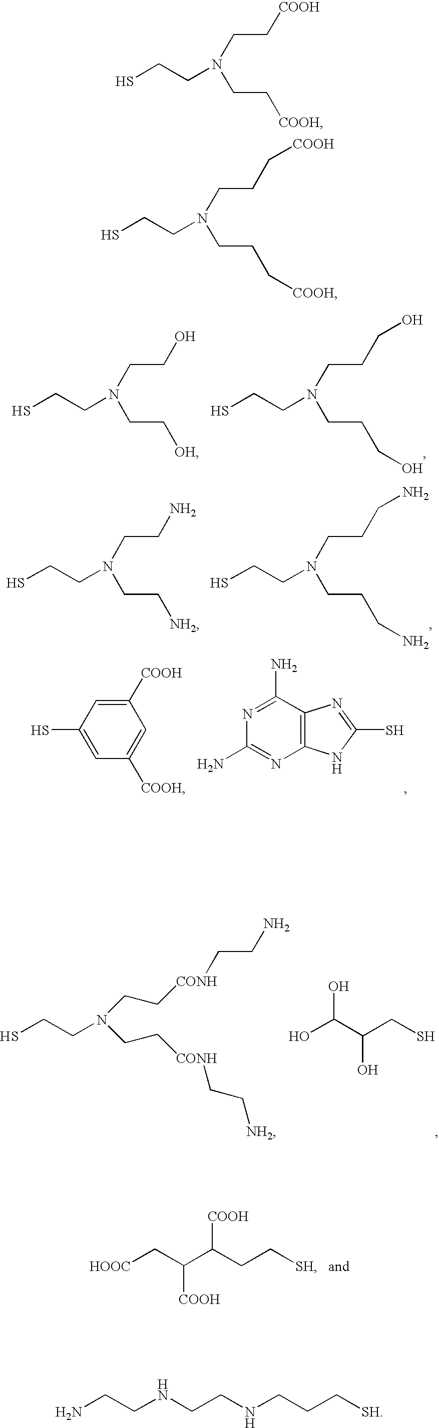

Exemplary capping reagents in which the coating reagent is hetero-bifunctional, i.e. 2 different coupling groups are present, include, but is not limited to

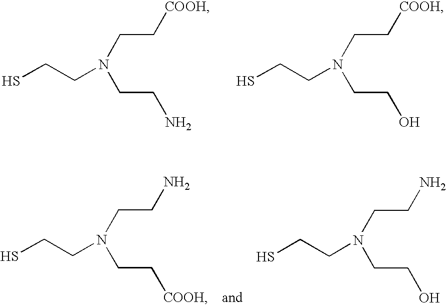

In another embodiment, the capping reagent couples with the coating reagent via polymerizable unsaturated groups, such as C═C double bonds, via any free radical polymerization mechanism. Specific examples of such capping reagents include, but are not limited to w-thiol terminated methyl methacrylate, 2-butenethiol, (E)-2-Butene-1-thiol, S-(E)-2-butenyl thioacetate, S-3-methylbutenyl thioacetate, 2-quinolinemethanethiol, and S-2-quinolinemethyl thioacetate.

The second component of the water-soluble shell surrounding the nanocrystal core is formed by coupling of a low molecular weight coating reagent bearing water-soluble groups to the capping reagent. A coupling agent may be optionally used to activate the coupling groups present in the capping reagent. The coupling agent and the coating reagent bearing the coupling moieties may be added sequentially, i.e. the coating reagent is added after the activation has been carried out; alternatively, the coating reagent may be added simultaneously along with the coupling agent.

In principle, any coupling agent that activates the coupling groups in the capping reagent can be used, as long as the coupling agent is chemically compatible with the capping reagent used for forming the first and the coating reagent used for forming the second layer, meaning that the coupling agent does not react with them to alter their structure. Ideally, no unreacted coupling agent should be present in the nanocrystal as the coupling agent molecules should be completely displaced by coating reagent molecules. However, in practical reality, it might be possible that unreacted residues of the coupling agent may nevertheless be present in the final nanocrystal.

The determination of an appropriate coupling agent is within the knowledge of the person of average skill in the art. One example of a suitable coupling reagent is 1-ethyl-3-[3-dimethylaminopropyl]carbodiimide (EDC) used in combination with sulfo-N-hydroxysuccinimide (NHS). Other types of coupling reagents may be used, including, but not limited to, imides and azoles. Some examples of imides which can be used are carbodiimides, succinimides and pthalimides. Some explicit examples of imides include 1-ethyl-3-[3-dimethylaminopropyl]carbodiimide (EDC), sulfo-N-hydroxysuccinimide, N,N′-Dicyclohexylcarbodiimide (DCC), N,N′-dicyclohexyl carbodiimide, N-(3-dimethylaminopropyl)-N′-ethylcarbodiimide, used in connection with N-hydroxysuccinimide or any other activation molecule.

In the case of a capping agent in which the coupling group comprises an unsaturated C═C bond, the coupling agent comprises an initiator such as tert-butyl peracetate, tert-butyl peracetate, benzoyl peroxide, potassium persulfate, and peracetic acid. Photoinitiation may also be applied to activate the unsaturated bonds in the coupling group in order to bring about coupling.

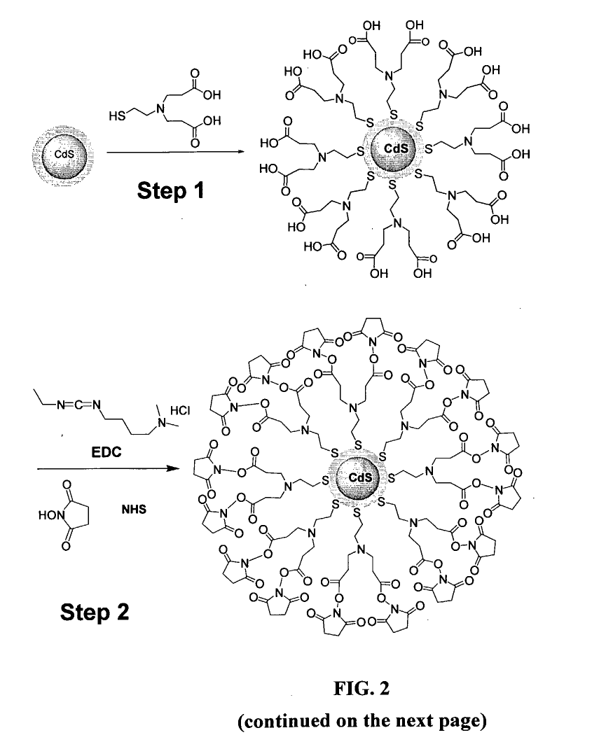

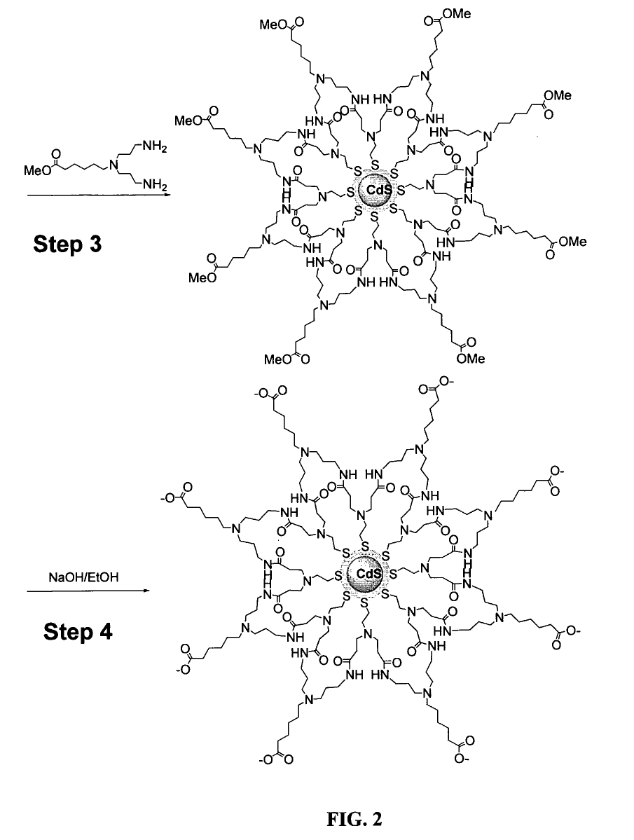

The coating reagent which is used for forming the second layer of the water-soluble shell may comprise one or more suitable coupling moieties that has coupling moieties which will react with activated coupling groups on the capping reagent. Typically, suitable coating reagents have at least 2 coupling moieties, i.e. in some embodiments, there are 2, 3 or 4 functional groups, for example, that are reactive towards the activated coupling groups of the capping reagent. As illustrated in FIG. 2, when at least two coupling moieties of the coating reagent are reacted with the capping reagent, the coating reagent becomes covalently coupled (“cross-linked”) to the capping reagent via the formation of, for example, ester or amide linkages, thereby forming a water soluble shell that surrounds the nanocrystal core.

The coupling of the coating reagent with the capping reagent can be carried out via any suitable coupling reaction scheme. Examples of suitable reaction schemes include free-radical coupling, amide coupling or ester coupling reactions. In one embodiment, the coating reagent to be coupled onto the capping reagent is coupled to the exposed coupling group on the capping reagent via a carbodiimide mediated coupling reaction. One preferred coupling reaction is the carbodiimide coupling reaction provided by 1-ethyl-3-[3-dimethylaminopropyl]carbodiimide] and promoted by sulfo-N-hydroxysuccinimide, in which carboxyl functional groups and amino functional groups in the coupling groups of the capping reagent and the coupling moieties on the coating reagent react to form covalent bonds.

In the context of the invention, the term ‘low molecular weight coating reagent’ as used to form the second layer of the water-soluble shell includes non-polymeric (‘small’) molecules. The molecular weight of the coating reagent can be low or high, depending on the type of groups present in the coating reagent molecule. If the coating reagent has, for example, small side chains, then the molecular weight of the coating reagent will be low. In the case of a coating reagent in which bulky side chains are present, then molecular weight of such a coating reagent molecule will be higher. Accordingly, in some embodiments, the upper limit of molecular weight of the coating reagent may be about 200, about 400, about 600 Daltons or about 1000. In other embodiments in which a high molecular weight or large spatial volume capping reagent is used, the upper limit may be higher, for example, about 1200, or about 1500 or about 2000 Daltons. In accordance with this definition, the term ‘low molecular weight coating reagent’ also includes oligomeric compounds which have a molecular weight of up to about 2000 Daltons, for example. The terms “coupling” and “covalent coupling” refer generally to any type of reaction which joins two molecules together to form one single, bigger entity, such as the coupling of an acid and an alcohol to form an ester, or the coupling of an acid and an amine to form an amide. Accordingly, any reaction that can couple the coupling groups and the coupling moieties present in the capping reagent and the coating reagent are within the meaning of the term. ‘Coupling’ also includes reacting one or more unsaturated groups (e.g. —C═C— double bonds) present as the coupling group in the capping reagent with a corresponding coupling moiety in the coating reagent via free radical coupling to covalently bond the coating reagent to the capping reagent layer.

The capping reagent and the coating reagent may each possess functional groups that are mutually reactive in order for polymerization to be carried out. In one embodiment, the coating reagent is a water soluble molecule comprising at least 2 coupling moieties, each having at least one copolymerizable functional group that can react with the coupling group on the capping reagent. In a specific embodiment, the coating reagent may be a water soluble molecule having the formula (II):

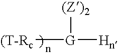

wherein

T is a moiety for adjusting solubility,

R_{c} is a moiety comprising at least 3 main chain carbon atoms,

G is selected from N, or C,

Z′ is a copolymerisable moiety,

n is an integer of 1 or 2, and

n′ is 0 or 1, wherein n′ is selected to satisfy the valence requirement of G.

Water-soluble shells with desirable properties can be obtained with capping reagents in which the moiety R_{c} has less than 30, preferably less than 20, or more preferably less than 12 main chain carbon atoms. In a preferred embodiment, R_{c} comprises between 3 to 12 main chain carbon atoms. Under specific experimental conditions, this range provided high coupling efficiency during the synthesis of the nanocrystal. The moiety T can be a polar/hydrophilic functional group for adjusting the solubility of the nanocrystal in the environment in which it is placed. Accordingly, it may impart hydrophilic, or hydrophobic characteristics to the shell, thus allowing the nanocrystal to be soluble in an aqueous environment as well as a non-aqueous environment. T may selected from polar groups such as hydroxyl groups, carboxyl groups, carbonyl groups, sulfonate groups, phosphate groups, amino groups, carboxamide groups, for example. The moiety T may also be hydrophobic, such as any aliphatic or aromatic hydrocarbon (e.g. fatty acid or benzene derivative), or any other organic moiety that is insoluble in water, in order to obtain a nanocrystal that is insoluble in an aqueous environment. Where T is hydrophobic, it can also be modified through the incorporation of hydrophilic moieties after the coating reagent has been copolymerised with the capping reagent. The moiety Z′ is a copolymerisable moiety that has functional groups that can copolymerise with the coupling moiety on the capping reagent. Suitable functional groups include, but are not limited to, —NH₂, —COOH or —OH, —Br, —C═C—, for example. Z′ may additionally comprise an aliphatic or cyclic carbon chain, preferably with at least 2 main chain carbon atoms.

In one embodiment, T may be derived from a cyclodextrin molecule. Cyclodextrin molecules have a large number of hydroxyl groups which improves water solubility of the resulting copolymer, and can also conjugate easily to biomolecules for biological labeling purposes. Examples of suitable cyclodextrins that are suitable include α-cyclodextrin, β-cyclodextrin, γ-cyclodextrin, Dimethyl-α-cyclodextrin, Trimethyl-α-cyclodextrin, Dimethyl-β-cyclodextrin, Trimethyl-β-cyclodextrin, Dimethyl-γ-cyclodextrin, and Trimethyl-γ-cyclodextrin.

In yet another embodiment, the coating reagent is a water soluble molecule selected from amino acids, preferably diamino acids or dicarboxylic amino acids. Specific examples of diamino-acids that are presently contemplated include 2,4-diaminobutyric acid, 2,3-diaminoproprionic acid or 2,5-diaminopentanoic acid, to name only a few. Dicarboxylic acids that are contemplated in the present invention include but are not limited to aspartic acid and glutamic acid.

In other embodiments, the coating reagent is a water soluble molecule selected from the group consisting of:

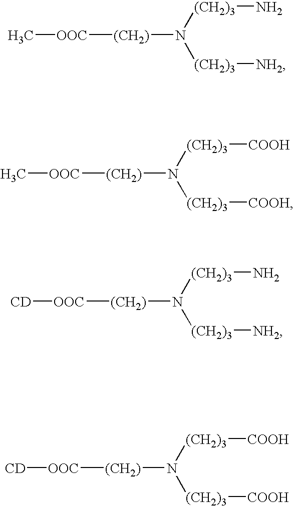

wherein CD is cyclodextrin, and

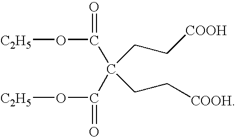

In another embodiment in which the capping reagent comprises unsaturated group (e.g. C═C double bonds), suitable coating reagents that may be used for coupling include dienes and tri-enes such as 1,4-butadiene, 1,5-pentadiene, and 1,6-hexadiene.

By functionalising the nanocrystal, it becomes possible for the nanocrystals of the present invention to be used in a variety of applications. In a further embodiment, the water soluble shell is functionalized by attaching an affinity ligand to the water soluble shell. Such a nanocrystal can detect the presence or absence of a substrate for which the affinity ligand has binding specificity. Contact, and subsequent binding, between the affinity ligand of the functionalized nanocrystal and a targeted substrate, if present in a sample, may serve a variety of purposes. For example, it can result in the formation of a complex comprising the functionalized nanocrystal-substrate which can emit a detectable signal for quantization, visualization, or other forms of detection. Contemplated affinity ligands include monoclonal antibodies, including chimeric or genetically modified monoclonal antibodies, peptides, aptamers, nucleic acid molecules, streptavidin, avidin, lectin, etc.

In accordance with the above disclosure, another aspect of the present invention concerns a method of preparing a water soluble nanocrystal.

Synthesis of the water-soluble shell can be carried out by first contacting and thereby reacting the capping reagent with the nanocrystal core. The contacting can be done either directly or indirectly. Direct contacting refers to the immersion of the nanocrystal core into a solution containing the capping reagent without the use of any coordinating ligand. Indirect contacting refers the use of a coordinating ligand to prime the nanocrystal core prior to contacting with the capping reagent. Indirect contacting typically comprises two steps. Both methods of contacting are feasible in the present invention. However, the latter method of indirect contacting is preferred as the coordinating ligand helps to speed up the attachment of the capping reagent to the surface of the nanocrystal core.

Indirect contacting will be elaborated as follows. In the first step of indirect contacting, the coordinating ligand is prepared by dissolving in an organic solvent. Next, the nanocrystal core is immersed in the organic solvent for a predetermined period of time, so that a sufficiently stable passivating layer is formed on the surface of the core of the nanocrystal (hereinafter referred to as “passivated nanocrystal”). This passivating layer serves to repel any hydrophilic species which may contact the nanocrystal core, thereby preventing any degradation of the nanocrystal. The passivated nanocrystal can be isolated and stored, if desired, for any desired period of time in the organic solvent containing the coordinating ligand. If desired, a suitable neutral organic solvent, for example, chloroform, methylene chloride, or tetrahydrofuran, may be added.

In the second step of indirect contacting, ligand exchange may be carried out in the presence of an organic solvent or in an aqueous solution. Ligand exchange (displacement) is carried out by adding an excess of the capping reagent to the passivated nanocrystal to facilitate contact of the passivated nanocrystals with the capping reagent. The contact time required to achieve high levels of displacement may be shortened by agitating or sonicating the reaction mixture for a required period of time. After a sufficient length of time, the capping reagent displaces the passivating layer and becomes itself attached to the nanocrystal, thus capping the surface of the nanocrystal core for subsequent coupling of the coating reagent.

The coordinating ligand used in indirect contacting can be any molecule that comprises a moiety having affinity toward the surface of the nanocrystal core. This affinity can manifest in the form of electrostatic interaction, covalent bonding or coordination bonding, for example. Suitable coordinating ligands include, but are not restricted to, hydrophobic molecules, or amphiphilic molecules comprising a hydrophobic chain attached to a hydrophilic moiety, such as a polar functional group. Examples of such molecules include trioctylphosphine, trioctylphosphine oxide, or mercaptoundecanoic acid. Other types of coordinating ligands that may be used include thiols, amines or silanes.

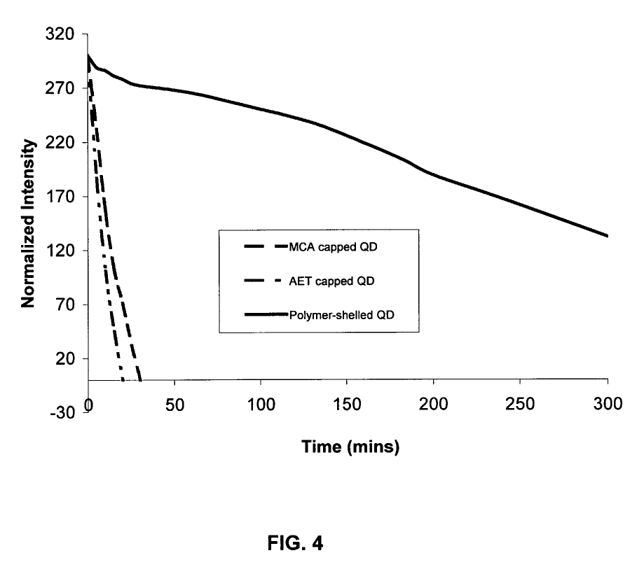

A scheme for carrying out coupling of the capping reagent with the coating reagent via the indirect contacting route is shown in FIG. 4. Firstly, nanocrystal cores may be prepared in coordination solvents such as trioctyl phosphine oxide (TOPO), resulting in the formation of a passivating layer on the nanocrystal core surface. Subsequently, the TOPO layer is displaced by the capping reagent. Displacement may occur by dispersion of TOPO-layered nanocrystals in a medium containing high concentrations of the capping reagent. This step is typically carried out either in an organic solvent or an aqueous solution. Preferred organic solvents include polar organic solvents such as pyridine, dimethylformamide (DMF), DMSO, dichloromethane, ether, chloroform, or tetrahydrofuran. Thereafter, the capping reagent to be coupled to the capping reagent may be prepared and added to the capped nanocrystal cores.

The method of the invention comprises, once the first layer of the water-soluble shell has been formed, the further step of coupling the nanocrystals capped with the capping reagent with a coating reagent having water-soluble groups is carried out. Coupling may be carried out in the presence of a coupling agent if desired. The coupling agent may be used to prime the capping reagent to render it reactive towards the coating reagent, or the coupling agent may be used to prime the coupling moieties of the coating reagent to render them reactive towards the capping reagent. In a preferred embodiment, EDC (1-ethyl-3-[3-dimethylaminopropyl]carbodiimide) can be used as a coupling agents, optionally assisted by sulfoNHS (sulfo-N-hydroxysuccinimide). Other types of coupling reagents, including cross-linking agents, may also be used. Examples include, but are not limited to, carbodiimides such as diisopropylcarbodiimide, Carbodicyclohexylimide, N,N′-dicyclohexylcarbodiimide (DCC; Pierce), N-succinimidyl-5-acetyl-thioacetate (SATA), N-succinimidyl-3-(2-pyridyldithio)propionate (SPDP), ortho-phenylenedimaleimide (o-PDM), and sulfosuccinimidyl 4-(N-maleimidomethyl)cyclohexane-1-carboxylate (sulfo-SMCC) and azoles. The coupling agent catalyzes the formation of amide bonds between carboxylic acids and amines by activating the carboxyl group to form an O-urea derivative. This derivative reacts readily with the nucleophilic amine groups thereby accelerating the coupling reaction.

For illustration, assume that x moles of capping reagent having x moles of coupling groups can be attached to every 1 mole of nanocrystal cores. If y moles of coating reagent contain x moles of coupling moieties to completely react with 1 mole of nanocrystal cores (attached with x moles of capping reagent), then the mixing ratio of coating reagent to nanocrystal is at least y moles of coating reagent per 1 mole of nanocrystal cores. In practice, capping reagents usually are reacted in excess to ensure complete capping on nanocrystals. Unreacted capping reagent can be removed via centrifugation, for example. The amount of coating reagent added to couple with the capped nanocrystal may be added in excess as well, typically in the region of about 10, or about 20, or about 30, to 1000 moles of coating reagent per mole of capped nanocrystal.

In order to couple the coating reagent to the capping reagent that has been capped to the surface of the nanocrystal core, the coating reagent is mixed with the capping reagent in the presence of a coupling agent. The coupling agent and the coating reagent may be added simultaneously to a solution containing the nanocrystal comprising the first layer (cf. Examples 1 and 2), or they may be added sequentially, the coating reagent being added after the coupling agent. The coupling agent acts as a initiator to activate the coupling groups and coupling moieties present in the capping reagent and the coating reagent, respectively. Thereafter, the coating reagent is coupled with the capping reagent to form a second layer that surrounds the nanocrystal core.

The coupling reaction can be carried out in an aqueous solution or in organic solvents. For example, the coupling reactions can be carried out in aqueous solutions, such as in water with suitable additives, including initiators, stabilizers or phase transfer reagents to improve the kinetics of the polymerization. It can also be carried out in a buffer solution, such as phosphate or ammonium buffer solution. In addition, the polymerization can be carried out in anhydrous organic solvents with suitable additives, such as coupling reagents and catalyst. Generally used organic solvents include DMF, DMSO, chloroform, dichloromethane, and THF.

Finally, once the coating reagent layer of the water soluble shell has been coupled to the capping reagent, a last step may be performed comprising reacting the coating reagent comprised in the second layer with a reagent suitable for exposing water soluble groups present in the second layer. For example, if the coating reagent used comprises an ester linkage (to protect carboxyl groups that may otherwise interfere in the formation of the second layer), the ester may be hydrolyzed by adding an alkaline solution (sodium hydroxide, for example) to the nanocrystal. So doing enables the carboxyl groups in the second layer to be exposed in the solution, thereby conferring water solubility to the nanocrystal.

The present invention further refers to a nanocrystal, as disclosed herein, that is conjugated to a molecule having binding affinity for a given analyte. By conjugating the nanocrystal to a molecule having binding affinity for a given analyte, a marker compound or probe is formed. In such a probe, the nanocrystal of the invention serves as a label or tag which emits radiation, for example in the visible or near infrared range of the electromagnetic spectrum, that can be used for the detection of a given analyte.

In principle every analyte can be detected for which a specific binding partner exists that is able to at least somewhat specifically bind to the analyte. The analyte can be a chemical compound such as a drug (e.g. Aspirin® or Ribavirin), or a biochemical molecule such as a protein (for example, an antibody specific for troponin or a cell surface protein) or a nucleic acid molecule. When coupled to an appropriate molecule with binding affinity (which is also referred to as the analyte binding partner) for an analyte of interest, such as Ribavirin, the resulting probe can be used for example in a fluorescent immunoassay for monitoring the level of the drug in the plasma of a patient. In case of troponin, which is a marker protein for damage of the heart muscle, and thus in general for a heart attack, a conjugate containing an anti-troponin antibody and an inventive nanocrystal can be used in the diagnosis of heart attack. In case of an conjugate of the inventive nanocrystals with an antibody that it specific for a tumor associated cell surface protein, this conjugate may be used for tumor diagnosis or imaging. Another example is a conjugate of the nanocrystal with streptavidin.

The analyte can also be a complex biological structure including but not limited to a virus particle, a chromosome or a whole cell. For example, if the analyte binding partner is a lipid that attaches to a cell membrane, a conjugate comprising a nanocrystal of the invention linked to such a lipid can be used for detection and visualization of a whole cell. For purposes such as cell staining or cell imaging, a nanocrystal emitting visible light is preferably used. In accordance with this disclosure the analyte that is to be detected by use of a marker compound that comprises a nanoparticle of the invention conjugated to an analyte binding partner is preferably a biomolecule.

Therefore, in a further preferred embodiment, the molecule having binding affinity for the analyte is a protein, a peptide, a compound having features of an immunogenic hapten, a nucleic acid, a carbohydrate or an organic molecule. The protein employed as analyte binding partner can be, for example, an antibody, an antibody fragment, a ligand, avidin, streptavidin or an enzyme. Examples of organic molecules are compounds such as biotin, digoxigenin, serotronine, folate derivatives, antigens, peptides, proteins, nucleic acids and enzymes and the like. A nucleic acid may be selected from, but not limited to, a DNA, RNA or PNA molecule, a short oligonucleotide with 10 to 50 bp as well as longer nucleic acids.

When used for the detection of biomolecules a nanocrystal of the invention can be conjugated to the molecule having binding activity via surface exposed groups of the host molecule. For this purpose, a surface exposed functional group on the coating reagent such as an amine, hydroxyl or carboxylate group may be reacted with a linking agent. A linking agent as used herein, means any compound that is capable of linking a nanocrystal of the invention to a molecule having binding affinity for any biological target. Examples of the types of linking agents which may be used to conjugate a nanocrystal to the analyte binding partner are (bifunctional) linking agents such as ethyl-3-dimethylaminocarbodiimide or other suitable coupling compounds which are known to the person skilled in the art. Examples of suitable linking agents are N-(3-aminopropyl)-3-mercapto-benzamide, 3-aminopropyl-trimethoxysilane, 3-mercaptopropyl-trimethoxysilane, 3-(trimethoxysilyl)propyl-maleimide, and 3-(trimethoxysilyl)propyl-hydrazide. The coating reagent may also be conjugated with a suitable linking agent that is coupled to the selected molecule having the intended binding affinity or analyte binding partner. For example, if the coating reagent comprises cyclodextrin moieties, then suitable linking agents may be used which may include, but is not limited to, ferrocene derivatives, adamantan compounds, polyoxyethylene compounds, aromatic compounds all of which have a suitable reactive group for forming a covalent bond with the molecule of interest.

Furthermore, the invention is also directed to a composition containing at least one type of nanocrystal as defined here. The nanocrystal may be incorporated into a plastic bead, a magnetic bead or a latex bead. Furthermore, a detection kit containing a nanocrystal as defined here is also part of the invention.

The invention is further illustrated by the following non-limiting examples and the attached drawings in which:

FIG. 1 depicts a generalized diagram of a water soluble nanocrystal of the invention (FIG. 1a), wherein FIG. 1b shows an enlarged schematic representation of the cross-linking interface formed between the capping reagent heptane-(4-N-ethylthiol)-1,7-dicarboxylic acid (used for forming the first layer) and di-(3-aminopropyl)-6-N-hexanoic acid methyl ester) used as coating agent for forming the second layer (cf. also FIG. 2). As can be seen from FIG. 1b, the nanocrystal comprises an interfacial region formed from the covalent bonding between at least two (neighboring) molecules of the capping reagent and one molecule of the coating reagent, such that the coating reagent molecules serves as a bridge linking the capping reagent molecules together.

FIG. 2 shows a schematic diagram of a method for synthesizing a water soluble nanocrystal encapsulated in a polyamide shell, formed via cross-linking using an diamine carboxyl ester (di-(3-aminopropyl)-6-N-hexanoic acid methyl ester) as coating reagent, and heptane-(4-N-ethylthiol)-1,7-dicarboxylic acid as the capping reagent. In this example, the formed second layer contains exposed carboxylic acid groups.

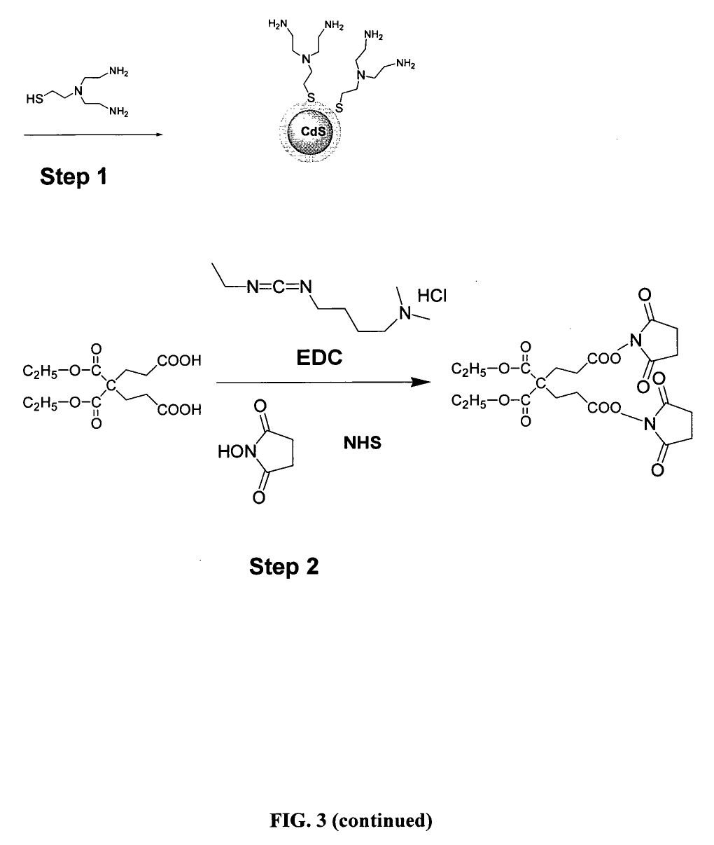

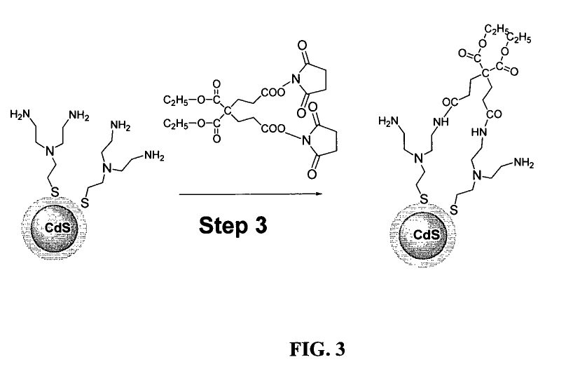

FIG. 3 shows a schematic diagram of a method for synthesizing a water soluble nanocrystal encapsulated in a polyamide water soluble shell, formed via cross-linking using pentane-(3-N-ethylthiol)-1,5-diamine as capping reagent for forming the first layer, and pentane-3,3-diethyl-carboxylic ester-1,5-dicarboxylic acid as coating agent for forming the second layer.

FIG. 4 shows the stability of shelled nanocrystals of the invention against chemical oxidation compared to the one of (CdSe)—ZnS core shell nanocrystals with were capped only with mercaptopropionic acid (MCA) or aminoethanethol (AET).

### EXAMPLE 1

### Preparation of Water-Soluble Nanocrystals with Cross-Linked Shell in Aqueous Solution

TOPO capped nanocrystals were first prepared in accordance with the following procedure.

Trioctylphosphine oxide (TOPO) (30 g) was placed in a flask and dried under vacuum (˜1 Torr) at 180° C. for 1 hour. The flask was then filled with nitrogen and heated to 350° C. In an inert atmosphere drybox the following injection solution was prepared: CdMe₂ (0.35 ml), 1 M trioctylphosphine-Se (TOPSe) solution (4.0 ml), and trioctylphosphine (TOP) (16 ml). The injection solution was thoroughly mixed, loaded into a syringe, and removed from the drybox.

The heat was removed from the reaction and the reaction mixture was transferred into vigorously stirring TOPO with a single continuous injection. Heating was resorted to the reaction flask and the temperature was gradually raised to 260-280° C. After the reaction, the reaction flask was allowed to cool to about 60° C., and 20 ml of butanol were added to prevent solidification of the TOPO. Addition of large excess of methanol causes the particles to flocculate. The flocculate was separated from the supernatant liquid by centrifugation; the resulting powder can be dispersed in a variety of organic solvents to produce an optically clear solution.

A flask containing 5 g of TOPO was heated to 190° C. under vacuum for several hours then cooled to 60° C. after which 0.5 ml trioctylphosphine (TOP) was added. Roughly 0.1-0.4 μmols of CdSe dots dispersed in hexane were transferred into the reaction vessel via syringe and the solvent was pumped off. Diethyl zinc (ZnEt₂) and hexamethyldisilathiane ((TMS)₂S) were used as the Zn and S precursor, respectively. Equimolar amounts of the precursors were dissolved in 2-4 ml TOP inside an inert atmosphere glove box. The precursor solution was loaded into a syringe and transferred to an additional funnel attached to the reaction flask. After the addition was completed the mixture was cooled to 90° C. and left stirring for several hours. Butanol was added to the mixture to prevent the TOPO from solidifying upon cooling to room temperature.

The (CdSe)—ZnS core shell nanocrystals thus formed were dissolved in chloroform with large excess of the 3-mercaptopropionic acid with a few drops of pyridine. The mixtures were subjected to ultrasonication for about 2 hours and was kept stirred at room temperature overnight. The formed precipitate was collected by centrifugation and washed with acetone to remove the excess of the acid. The residue was briefly dried with a stream of argon. The resultant nanocrystals, coated with molecules of carboxylic acid forming the first layer covering/surrounding the nanocrystal core, were then dissolved in water or buffer solution (cf., FIG. 2, step 1). The nanocrystals in aqueous solution were centrifuged once more, filtered through a 0.2 μm filter, degassed with argon and stored at 25° C. before use.

For the formation of the cross-linking interface and subsequently the polymerization with the coating reagent layer comprised in the second layer, the carboxylic acid-capped nano crystals were dissolved in an aqueous buffer system. EDC (1-ethyl-3-[3-dimethylaminopropyl]carbodiimide) and sulfoNHS (sulfo-N-hydroxysuccinimide) were added as cross-linking agents to the nanocrystals solution in 500-1000 time excess. The resulting solution was stirred at room temperature for 30 minutes for activation of the functional groups involved in the formation of the cross-linking interface (cf., FIG. 2, step 2). The mixture containing the carboxylic acid-capped nanocrystals, EDC and sulfoNHS was added was added drop-wise with stirring to a solution of diamino-carboxylmethyl ester in the same buffer. The mixture was stirred for 2 hours at room temperature and then left at 4° C. overnight for formation of the cross-linking interface and covalently coupling the coating reagent that is comprised in the second layer to the first layer (cf. FIG. 2. step 3). For releasing the water soluble carboxyl groups of the diamino-carboxyl ester (i.e. hydrolysis of methyl ester bond) and thus forming the second water-soluble layer, then 0.1 N NaOH and ethanol was added and the solution was kept stirred at room temperature for another 6 hours (cf. FIG. 2. step 4). The solution was centrifuged to remove any solids and stored in aqueous solution as stock solution at 4° C.

The obtained quantum dots can also be purified by organic solvent extraction. After the reaction (formation of the cross-linking interface and covalently coupling the coating reagent that is comprised in the second layer to the first layer) was completed, the solution was extracted with ethyl acetate to extract the polymer-shelled quantum dots with ester surface from the organic solvent. The organic solvents thus obtained were combined and dried, and then removed by rotary evaporator and dissolved in ethanol and 0.1 N NaOH for hydrolysis of the ester bond and formation of the water soluble nanocrystals. The solution was kept constantly stirred at room temperature for 4 hours, and then neutralized. The obtained clear solution was centrifuged to remove any trace amounts of solid and stored in aqueous solution at room temperature after degassing.

The physical-chemical properties of the obtained cross-linked water soluble shelled nanocrystals of the invention were compared to those of (CdSe)—ZnS core shell nanocrystals with were capped only with mercaptopropionic acid (MCA) or aminoethanethol (AET) as follows: To an aqueous solution of the nanocrystals, H₂O₂ was added in a final concentration of 0.15 mol/l and the chemical behaviour followed photospectroscopially. For the nanocrystals that were coated only with MCA or AET oxidation of the nanocrystals was immediately detected and the nanocrystals precipitated within 30 minutes. In contrast, the shelled nanocrystals of the invention were significantly more stable against chemical oxidation which occurred only slowly.

In a further experiment (data not shown), when 0.1 M CdSO₄ solution was added to either (CdSe)—ZnS core shell nanocrystals capped with MCA only or to shelled nanocrystals of the invention, the MCA capped nanocrystals precipitated quickly from the solution. Contrasting, the nanocrystals of the invention maintained stable in the solution meaning the addition of cadmium ions has no significant effect on their stability.

Similarly, the photochemical stability of the shelled nanocrystals was also significantly improved in comparison to the MCA capped nanocrystals (data not shown). When exposed to UV light with a wavelength of 254 nm, the MCA capped nanocrystals were found to precipitate from the solution in 48 hours whereas the shelled nanocrystals of the invention were stable for 4 days. The fluorescence intensity was also found to be stable for a long time.

### EXAMPLE 2

### Preparation of Water-Soluble Nanocrystals with Cross-Linked Shell in Organic Solution

TOPO capped nanocrystals were prepared in accordance with Example 1 and dissolved in chloroform, along with excess amount of pentane-(3-N-ethylthiol)-1,5-diamine for formation of the first layer (cf. FIG. 3, Step 1). The mixture was left at room temperature overnight. Formed precipitates were collected by centrifugation and then washed with methanol, dried briefly with argon gas. The obtained nanocrystals were dissolved in anhydrous DMF (50 ml).

In another flask, pentane-3,3-diethyl-carboxylic ester-1,5-dicarboxylic acid (as coating agent comprised in the second layer) was dissolved in DMF with 5 equiv. of EDC and NHS, and stirred at room temperature for 20 minutes under nitrogen protection (cf. FIG. 3, Step 2). The solution was added slowly to the nanocrystal solution for covalent coupling with the coating agent (cf. FIG. 3, Step 3). After stirring the resulting solution for 2 hours at room temperature, the DMF solvent was evaporated under reduced pressure by using a rotavapor system. The obtained slurry was dissolved in 5 ml of water and then 5 ml of 1 M EtONa/EtOH solution was added and stirred at room temperature for another 2 hours to form the solvent-exposed water soluble bonds in the second layer. The resulting solution was washed twice (5 ml×2) with ether to remove any trace of the additives or un-reacted starting materials. It was then neutralized with 0.1 N HCl aqueous solution for storage. Further purification was carried out by centrifugation of the polymer-coated nanocrystals in acidic solution and re-dissolving the nanocrystals in water by adjustment of the pH value of the solution.

1. A water soluble nanocrystal comprising:
a nanocrystal core comprising at least one metal M1 selected from an element of subgroup Ib, subgroup IIb, subgroup IVb, subgroup Vb, subgroup VIb, subgroup VIIb, subgroup VIIb, main group II, main group III or main group IV of the periodic system of the elements (PSE), and further comprising
a first layer comprising a capping reagent attached to the surface of the core of the nanocrystal, said capping reagent having at least two coupling groups,
and a second layer comprising a low molecular weight coating reagent having at least two coupling moieties covalently coupled with the coating reagent, and at least one water soluble group for conferring water solubility to the second layer.

2. A water soluble nanocrystal comprising:
a nanocrystal core comprising at least one metal M1 selected from an element of main group II, subgroup VIIA, subgroup VIIIA, subgroup IB, subgroup IIB, main group III or main group IV of the periodic system of the elements (PSE), and at least one element A selected from main group V or main group VI of the PSE, and further comprising
a first layer comprising a capping reagent attached to the surface of the core of the nanocrystal, said capping reagent having at least two coupling groups,
and a second layer comprising a low molecular weight coating reagent having at least two coupling moieties covalently coupled with the coating reagent, and at least one water soluble group conferring water solubility to the second layer.

3. The nanocrystal of claim 2, wherein the capping reagent comprises a terminal group having affinity for the surface of the core of the nanocrystal.

4. The nanocrystal of claim 3, wherein the terminal group is selected from the group consisting of sulfhydryl, amino, amine-oxide and phosphino groups.

5. The nanocrystal of claim 2, wherein the at least two coupling groups of the capping reagent are spaced apart from the terminal group by a hydrophobic region.

6. The nanocrystal of claim 4, wherein each of the at least two coupling groups comprises a functional group independently selected from amino, hydroxyl, carbonyl, carboxyl, nitrile, nitro, isocyanate, epoxide, anhydride and halide groups.

7. The nanocrystal of claim 2, wherein the capping reagent is a molecule having the formula (I): 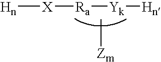
wherein
X is a terminal group selected from S, N, P, or O═P,
Rₐ is a moiety comprising at least 2 main chain carbon atoms,
Y is selected from N, C, —COO—, or —CH₂O—,
Z is a moiety comprising a polar functional group,
k is 0 or 1,
m is an integer from 1 to 3,
n is an integer from 0 to 3, and
n′ is an integer from 0 to 2, wherein n′ is selected to satisfy the valence requirement of Y.

8. The nanocrystal of claim 7, wherein the moiety F, comprises 2 to 50 main chain atoms.

9. The nanocrystal of claim 7, wherein Rₐ is selected from the group consisting of alkyl, alkenyl, alkoxy and aryl moieties.

10. The nanocrystal of claim 9, wherein each of Rₐ is a moiety independently selected from the group consisting of ethyl, propyl, butyl, pentyl, cyclopentyl, cyclohexyl, cyclo-octyl, ethoxy, and benzyl.

11. The nanocrystal of claim 7, wherein Z is a functional group selected from the group consisting of amino, hydroxyl, carbonyl, carboxyl, nitrile, nitro, isocyanate and halide groups.

12. The nanocrystal of claim 11, wherein Z comprises 2 to 50 main chain atoms.

13. The nanocrystal of claim 12, wherein Z further comprises an amide or an ester linkage.

14. The nanocrystal of claim 2, wherein the capping reagent comprises two identical coupling groups.

15. The nanocrystal of claim 14, wherein the capping reagent is a compound selected from the group consisting of:

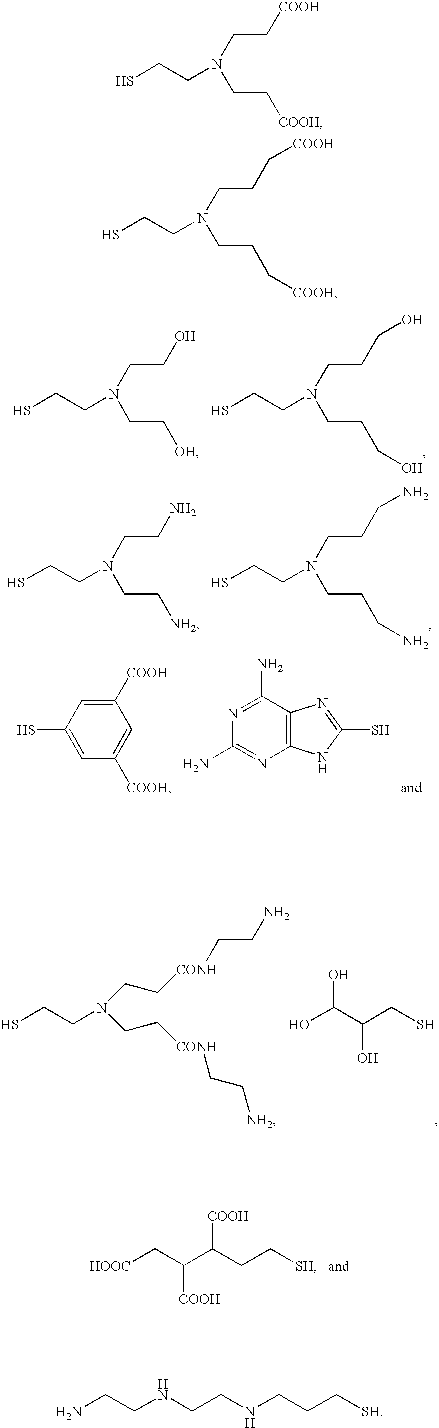

16. The nanocrystal of claim 2, wherein the capping reagent comprises two different coupling groups.

17. The nanocrystal of claim 16, wherein the capping reagent is selected from the group consisting of:

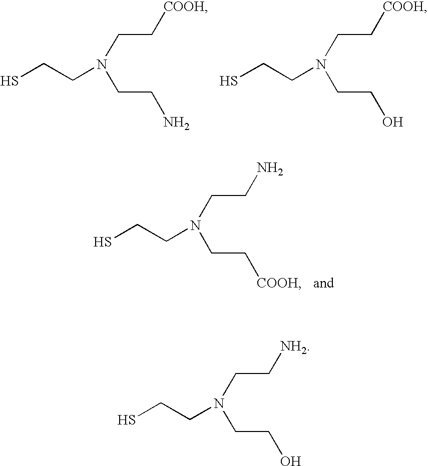

18. The nanocrystal of claim 2, wherein the coupling group of the capping reagent comprises a polymerizable unsaturated carbon-carbon bond.

19. The nanocrystal of claim 18, wherein the capping reagent is selected from the group consisting of w-thiol terminated methyl methacrylate, 2-butenethiol, (E)-2-Butene-1-thiol, S-(E)-2-butenyl thioacetate, S-3-methylbutenyl thioacetate, 2-quinolinemethanethiol, and S-2-quinolinemethyl thioacetate.

20. The nanocrystal of claim 2, wherein the coating reagent comprised in the second layer comprises a water soluble molecule having the general formula (II): 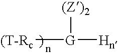
wherein
T is a hydrophilic moiety,
R_{c} is a moiety comprising at least 2 main chain carbon atoms,
G is selected from N, P or C, or Si
Z′ is a coupling moiety,
m′ is 2 or 3,
n is 1 or 2, and
n′ is 0 or 1, wherein n′ is selected to satisfy the valence requirement of G.

21. The nanocrystal of claim 20, wherein T comprises a functional group selected from the group consisting of carboxyl, amino, nitro, hydroxyl, carbonyl groups and derivatives thereof.

22. The nanocrystal of claim 20, wherein R_{c} comprises 3 to 6 main chain carbon atoms.

23. The nanocrystal of claim 20, wherein Z′ comprises at least 6 main chain carbon atoms.

24. The nanocrystal of claim 23, wherein Z′ further comprises at least one functional group selected from the group consisting of amino, hydroxyl, carbonyl, carboxyl, nitrile, nitro, isocyanate, epoxide, anhydride and halide groups.

25. The nanocrystal of claim 24, wherein each of the coupling moieties Z′ are identical.

26. The nanocrystal of claim 25, wherein the coating reagent is selected from the group consisting of a diamine, dicarboxylic acid, and a diol.

27. The nanocrystal of claim 26, wherein the diamine is selected from 2,4-diaminobutyric acid or 2,3-diaminopropionic acid.

28. The nanocrystal of any one of claims 26, wherein the coating reagent is selected from the group consisting of: 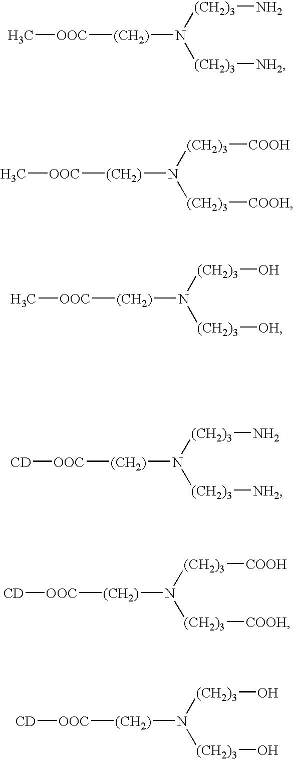
wherein CD is cyclodextrin, and

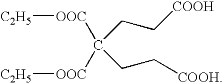

29. The nanocrystal of claim 24, wherein each of the coupling moieties Z′ are different.

30. The nanocrystal of claim 29, wherein the coating reagent is selected from the group consisting of:

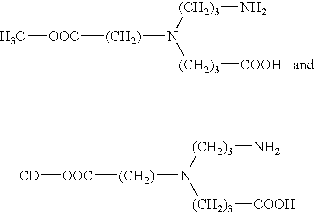

31. The nanocrystal of claim 18, wherein the coating reagent comprises a diene.

32. The nanocrystal of claim 31, wherein the diene is selected from the group consisting of 1,4-butadiene, 1,5-pentadiene and 1,6-hexadiene.

33. The nanocrystal of claim 2, wherein the nanocrystal is a core-shell nanocrystal.

34. The nanocrystal of claim 33, wherein the metal is selected from the group consisting of Zn, Cd, Hg, Mn, Fe, Co, Ni, Cu, Ag, and Au.

35. The nanocrystal of claim 33, wherein the element A is selected from the group consisting of S, Se, and Te.

36. The nanocrystal of claim 35, wherein the nanocrystal is a core shell nanocrystal selected from the group consisting of CdS, CdSe, MgTe, CdTe, ZnS, ZnSe, ZnTe, HgS, HgSe, and HgTe.

37-43. (canceled)

44. The nanocrystal of claim 2, further comprising a molecule having binding affinity for a given analyte being conjugated to the second layer of the polymer shell.

45-46. (canceled)

47. A method of detecting an analyte using a nanocrystal as defined in claim 2.

48. A method of preparing a water soluble nanocrystal comprising:
providing a nanocrystal core comprising at least one metal M1 selected from an element of subgroup Ib, subgroup IIb, subgroup IVb, subgroup Vb, subgroup VIb, subgroup VIIb, subgroup VIIIb, main group II, main group III or main group IV of the periodic system of the elements (PSE),
reacting the nanocrystal core with a capping reagent, thereby attaching the capping reagent to the surface of the nanocrystal core and forming a first layer surrounding the nanocrystal core,
and
coupling the capping reagent with a low molecular weight coating reagent having at least at least two coupling moieties that are reactive towards the at least two coupling groups of the capping reagent, and at least one water soluble group for conferring water solubility to the second layer, thereby forming a second layer covalently coupled to the first layer and completing the formation of a water soluble shell surrounding the nanocrystal core.

49. A method of preparing a water soluble nanocrystal comprising:
providing a nanocrystal core comprising at least one metal M1 selected from the group consisting of an element of subgroup IIB-VIB, IIIB-VB or IVB, main group II or main group III of the periodic system of the elements (PSE), and at least one element A selected from an element of the main group V or VI of the periodic system of the elements,
reacting the nanocrystal core with a capping reagent, thereby attaching the capping reagent to the surface of the nanocrystal core and forming a first layer surrounding the nanocrystal core,
and
coupling the capping reagent with a low molecular weight coating reagent having at least at least two coupling moieties that are reactive towards the at least two coupling groups of the capping reagent, and at least one water soluble group for conferring water solubility to the second layer, thereby forming a second layer covalently coupled to the first layer and completing the formation of a water soluble shell surrounding the nanocrystal core.

50. The method of claim 49, wherein the capping reagent is hydrophilic.

51. The method of claim 49, wherein the capping reagent is hydrophobic.

52. The method of claim 49, wherein each coupling group present in the capping reagent comprises a functional group selected from amino, hydroxyl, carbonyl, carboxyl, nitrile, nitro, isocyanate, epoxide, anhydride and halide groups.

53. The method of claim 49, wherein the capping reagent has the formula (I): 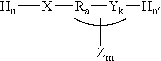
wherein
X is a terminal group selected from S, N, P, or O═P,
Rₐ is a moiety comprising at least 2 main chain carbon atoms,
Y is selected from N, C, —COO—, or —CH₂O—,
Z is a moiety comprising a polar functional group,
k is 0 or 1,
n is an integer from 0 to 3,
n′ is an integer from 0 to 2, wherein n′ is selected to satisfy the valence requirement of Y, and
m is an integer from 1 to 3.

54. The method of claim 53, wherein the capping reagent is a compound selected from the group consisting of:

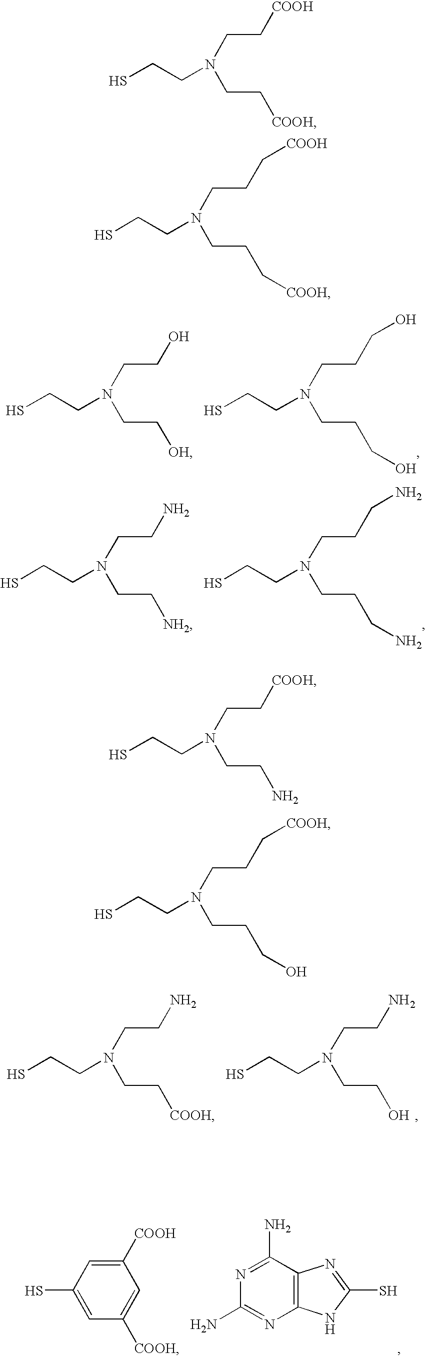

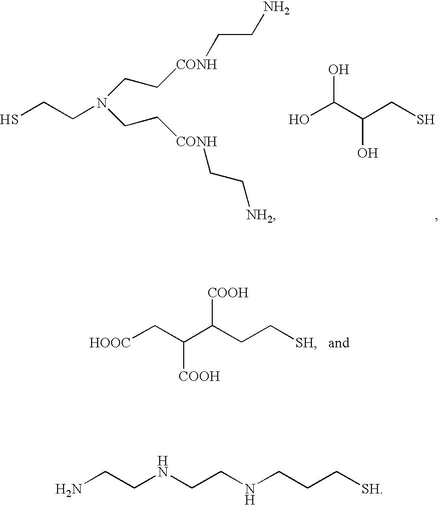

55. The method of claim 49, further comprising the step of activating the coupling groups of the capping reagent before coupling the coating reagent to the capping reagent.

56. The method of claim 55, wherein the step of activating comprises reacting the nanocrystal comprising the first layer of capping reagent with a coupling agent.

57. The method of claim 56, wherein the coupling agent is selected from the group consisting of 1-ethyl-3-[3-dimethylaminopropyl]carbodiimide (EDC), sulfo-N-hydroxysuccinimide, N,N′-Dicyclohexylcarbodiimide (DCC), N,N′-dicyclohexyl carbodiimide, N-(3-dimethylaminopropyl)-N′-ethylcarbodiimide, and N-hydroxysuccinimide.

58. The method of claim 49, wherein coupling the capping reagent with a coating reagent comprises adding the coating reagent and the coupling agent together to a solution containing nanocrystal cores having the first layer.

59. The method of claim 49, wherein the coupling is carried out in an aqueous buffer solution.

60. The method of claim 59, wherein the aqueous buffer solution comprises a phosphate or ammonium buffer solution.

61. The method of claim 49, wherein the coupling is carried out in a polar organic solvent.

62. The method of claim 61, wherein the organic solvent is selected from the group consisting of pyridine, DMF, and chloroform.

63. The method of claim 49, wherein the coating reagent comprised in the second layer comprises a water soluble molecule having the general formula (II): 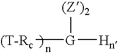
wherein
T is a hydrophilic moiety,
Rₑ is a moiety comprising at least 2 main chain carbon atoms,
G is selected from N, P or C, or Si
Z′ is a coupling moiety,
m′ is 2 or 3,
n is 1 or 2, and
n′ is 0 or 1, wherein n′ is selected to satisfy the valence requirement of G.

64. The method of claim 63, wherein the coating reagent is selected from the group consisting of: 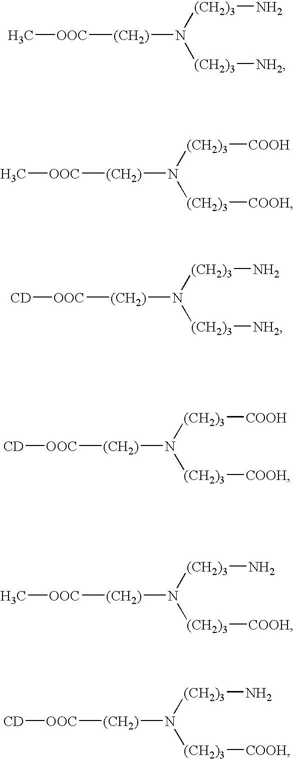
wherein CD is cyclodextrin, and

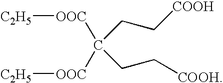

65. The method of claim 49, further comprising reacting the polymer comprised in the second layer with a reagent suitable for exposing water soluble groups present in the second layer.
